(19) United States
(12) Patent Application Publication
(10) Pub. No.: US 2013/0094807 A1
(43) Pub. Date: Apr. 18, 2013

(54) OPTICAL COUPLING SYSTEM FOR USE IN AN OPTICAL COMMUNICATIONS MODULE, AN OPTICAL COMMUNICATIONS MODULE THAT INCORPORATES THE OPTICAL COUPLING SYSTEM, AND A METHOD

(71) Applicants: Bing Shao, Sunnyvale, CA (US); Ye Chen, San Jose, CA (US); Xiaozhong Wang, Sunnyvale, CA (US)

(72) Inventors: Bing Shao, Sunnyvale, CA (US); Ye Chen, San Jose, CA (US); Xiaozhong Wang, Sunnyvale, CA (US)

(73) Assignee: AVAGO TECHNOLOGIES FIBER IP (SINGAPORE) PTE. LTD., SINGAPORE (SG)

(21) Appl. No.: 13/271,486

(22) Filed: Oct. 12, 2011

(51) Int. Cl. G02B 6/32

(52) U.S. Cl. 385/33

(57) ABSTRACT

An optical communications module is provided with an optical coupling system that includes a reflective and focusing (RAF) lens and an index-matching material that together allow air gaps along the optical pathway, which are typically associated with the use of refractive optical elements used in known optical communications modules, to be eliminated. Eliminating these air gaps allows Fresnel reflection along the optical pathway to be eliminated, or at least greatly reduced. Eliminating or reducing Fresnel reflection reduces insertion loss and optical crosstalk in the optical communications module.

### TECHNICAL FIELD OF THE INVENTION

The invention relates to an optical communications module having an optical coupling system that reduces the occurrence of Fresnel reflection within the optical coupling system.

### BACKGROUND OF THE INVENTION

An optical transmitter (Tx) module is an optical communications device used to transmit optical data signals over optical waveguides (e.g., optical fibers) of an optical communications network. A typical optical Tx module includes input circuitry, a laser driver circuit, one or more laser diodes, and an optical coupling system. The input circuitry typically includes buffers and amplifiers for conditioning an input data signal, which is then provided to the laser driver circuit. The laser driver circuit receives the conditioned input data signal and produces electrical modulation and bias current signals, which are provided to the laser diode to cause it to produce an optical data signal. The optical data signal is then directed by the optical coupling system into the end of the optical fiber. The end of the optical fiber may be directly attached to the optical Tx module or it may be held within a connector that mates with the optical Tx module.

Traditionally, the optical coupling system comprises a lens block that includes a refractive lens having a surface that is convex relative to the end face of the optical fiber. The refractive lens is separated from the end face of the fiber by an air gap. This air gap creates two interfaces at which there is a mismatch between indexes of refraction: one interface where the lens block and the air gap meet and the other interface where the air gap and the fiber end face meet. Fresnel reflection occurs at these two interfaces. Fresnel reflection contributes to insertion loss, which can be problematic, especially in power-limited systems. Fresnel reflection can also contribute to optical crosstalk, which is also undesirable, especially in bi-directional links.

A need exists for an optical communications module having an optical coupling system that greatly reduces Fresnel reflection and the problems and disadvantages associated therewith.

### SUMMARY OF THE INVENTION

The invention is directed to an optical communications module having an optical coupling system that greatly reduces Fresnel reflection, and a method for optically coupling light between an optical Tx or Rx portion of an optical communications module and a first end of a first optical fiber mechanically coupled with a first optical port of the optical communications module. The optical communications module comprises an optical Tx and/or Rx portion, an optical coupling system and a refractive index-matching material. In the case in which the optical communications module includes an optical Tx portion, the optical Tx portion includes at least a first light source for producing a first light beam and a first collimating lens for collimating the first light beam to produce a first collimated light beam. The optical coupling system is positioned to receive a first collimated light beam corresponding to at least a portion of the first collimated light beam produced in the optical Tx portion.

The optical coupling system includes at least a first reflective and focusing (RAF) lens. If light is being transmitted by the optical communications system, the RAF lens reflects the first collimated light beam received from the optical Tx portion along a first optical pathway of the optical coupling system toward the first optical port and focuses the received collimated light beam on the first end of the first optical fiber. The first optical pathway extends from the first RAF lens to the first optical port. The optical coupling system is formed in a piece of material that is transparent to a wavelength of the first light beam produced by the first light source and that is devoid of air gaps at least along the first optical pathway. The refractive index-matching material is disposed in between, and in contact with, the first optical port and the first end of the first optical fiber such that no air gaps exist in between the first optical port and the first end of the first optical fiber.

If light is being received by the optical communications system, the RAF lens receives a light beam passing out of a first end of a first optical fiber and reflects and focuses the light beam onto a first optical element of the optical Rx portion. The first optical element of the Rx portion then couples the light beam onto a first light detector of the optical Rx portion.

The method, in accordance with one embodiment, comprises receiving a first collimated light beam produced by an optical Tx portion of an optical Tx module in an optical coupling system of the module such that the received collimated light beam is incident on a first RAF lens of the optical coupling system. The first RAF lens reflects the received first collimated light beam along the first optical pathway toward the first end of the first optical fiber and focuses the first collimated light beam on the first end of the first optical fiber.

The method, in accordance with another embodiment, comprises receiving a light beam output from a first end of a first optical fiber mechanically coupled to a first optical port of an optical Rx module such that the received light beam is incident on a first RAF lens of an optical coupling system of the optical Rx module. The light beam propagates along a first optical pathway that extends from the first optical port to the first RAF lens. The first RAF lens reflects and focuses the light beam onto a first optical element of an optical Rx portion of the module, which couples the light onto a first light detector of the module.

Because the piece of material in which the optical coupling system is formed is devoid of air gaps at least along the first optical pathway, and because the refractive index-matching material is disposed in between, and in contact with, the first optical port and the first end of the first optical fiber such that no air gaps exist in between the first optical port and the first end of the first optical fiber, Fresnel reflection in the optical coupling system at least along the first optical pathway is reduced or eliminated.

These and other features and advantages of the invention will become apparent from the following description, drawings and claims.

### BRIEF DESCRIPTION OF THE DRAWINGS

FIG. 1 illustrates a schematic side-view diagram of an optical communications module that incorporates the optical coupling system in accordance with an illustrative embodiment.

FIG. 2 illustrates a schematic side-view diagram of an optical communications module that incorporates the optical coupling system in accordance with another illustrative embodiment.

FIG. 3 illustrates a top perspective view of a cross-section of a parallel optical communications module that exemplifies one possible physical manifestation of the schematically-illustrated optical communications module shown in FIG. 1.

### DETAILED DESCRIPTION OF AN ILLUSTRATIVE EMBODIMENT

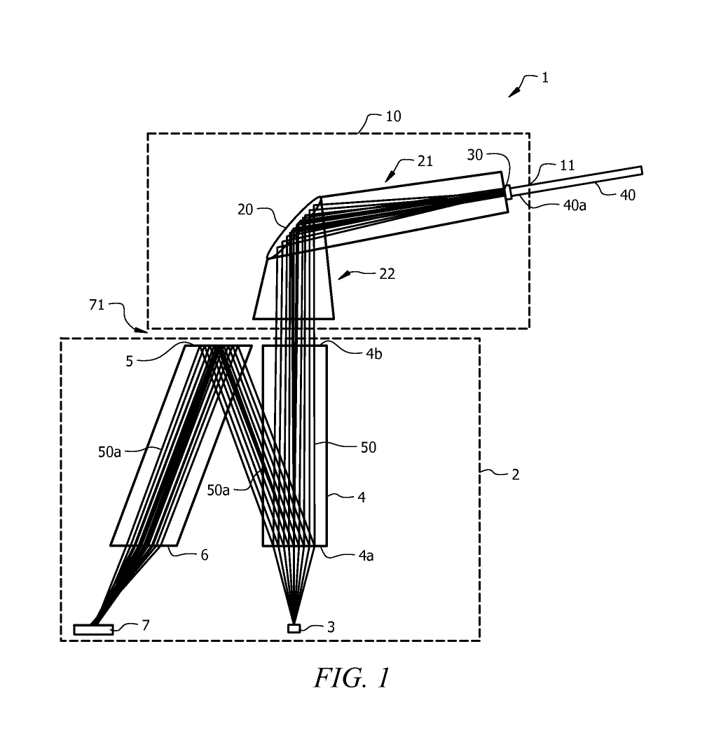

In accordance with an embodiment of the invention, an optical communications module is provided with an optical coupling system that includes at least one reflective and focusing (RAF) lens and an index-matching material that together allow the aforementioned air gap to be eliminated, thereby allowing Fresnel reflection to be eliminated, or at least greatly reduced. In known optical coupling systems that use refractive lenses, the aforementioned air interfaces cannot be eliminated because to do so would eliminate the intended optical effect of the optical coupling system. The reason for this is that a refractive optic element relies on a refractive index mismatch created by a curved dielectric (plastic/glass)—air interface in order to achieve the desired optical effect, i.e., refraction of light. By using the reflective lens of the invention in combination with the index-matching material, the air gap is eliminated while still allowing the optical coupling system to achieve the desired optical effect. Eliminating the air gap allows Fresnel reflection to be greatly reduced or eliminated, which decreases insertion loss and optical crosstalk. Illustrative, or exemplary, embodiments will now be described with reference to FIGS. 1 - 3.

FIG. 1 illustrates a schematic side-view diagram of an optical communications module 1 that incorporates an optical coupling system 10 in accordance with an illustrative embodiment. In accordance with this illustrative embodiment, the optical communications module 1 is an optical TX module. It should be noted, however, that the optical communications module 1 may instead be an optical Rx module, as will be described below in more detail. It should also be noted that the optical communications module 1 may instead be an optical transceiver module that includes both an optical Tx module and an optical Rx module. The term “optical communications module” is intended to denote a module that has transmit capability, but not receive capability, a module that has receive capability, but not transmit capability, and a module that has both transmit and receive capability.

The optical communications module 1 is not limited to having any particular configuration. In accordance with this illustrative embodiment, the optical communications module 1 is an optical Tx module that has an optical Tx portion 2 that includes at least one optoelectronic device 3, a collimating lens 4, a reflective surface or lens 5, a feedback (FB) monitoring lens 6, and an FB light detector 7. In accordance with this illustrative embodiment, the optoelectronic device 3 is a light source. The light source 3 is typically a laser diode, such as, for example, a vertical cavity surface emitting laser diode (VCSEL) or an edge-emitting laser diode. The light source 3 may, however, be some other type of light source, such as, for example, a light emitting diode (LED). The FB monitoring light detector 7 is typically a photodiode, such as, for example, a positive-intrinsic-negative (PIN) diode, although other types of suitable light detectors may be used. For purposes of discussion, it will be assumed that the light source 3 is a laser diode and that the light detector 7 is a photodiode.

The optical coupling system 10 also is not limited to having any particular configuration, except that it includes at least one RAF lens 20 and a refractive index-matching material 30 disposed between the RAF lens 20 and an end 40a of an optical waveguide 40. The refractive index-matching material 30 ensures that no air gaps exist in an optical pathway 21 that extends from the RAF lens 20 to the end 40a of the optical waveguide 40. For purposes of discussion, it will be assumed that the optical waveguide 40 is an optical fiber.

The end 40a of the optical fiber 40 may be either directly or indirectly mechanically coupled to the optical coupling system 10. In the case of a direct mechanical coupling, which is what is shown in FIG. 1, the end 40a of the optical fiber 40 is secured to the inside of an opening 11 formed in the material that comprises the optical coupling system 10. Thus, the opening 11 corresponds to an optical port of the optical coupling system 10. The refractive index-matching material (e.g., refractive index-matching epoxy) 30 is disposed within the optical port 11 and envelopes the end 40a of the optical fiber 40. This ensures that no air gaps exist between the end 40a of the optical fiber 40 and the optical port 11. The refractive index-matching material 30 has a refractive index value that matches, or nearly matches, the refractive index values of the material of which the optical coupling system 10 is made and of the material of which the optical fiber 40 is made. Because the materials of which the optical coupling system 10 and the fiber 40 are made typically have different refractive indexes, the refractive index-matching material 30 will typically be chosen to have a refractive index value that is in between the refractive index values of the materials of which the optical coupling system 10 and the fiber 40 are made.

The optical coupling system 10 typically comprises a solid piece of material that is transparent to an operating wavelength of the laser diode 3. The material is “solid” in that no air gaps exist in the material, other than any air gap that may be intentionally formed by removing a portion of the material. At the very least, the portion of the material that comprises the optical pathway 21 is devoid of air gaps. Therefore, no air gaps exist in between the RAF lens 20 and the end 40a of the optical fiber 40.

In the case of an indirect mechanical coupling of the fiber end 40a to the optical port 11, a connector (not shown for purposes of clarity) will be used to mechanically couple the fiber end 40a with the optical port 11. In this case, mating features will exist on the optical coupling system 10 and on the connector for mechanically coupling them together. The refractive index-matching material 30 (e.g., refractive index matching epoxy) will be disposed at the interface between the connector and the optical coupling system 10 such that no air gaps exist between the end 40a of the optical fiber 40 and the optical coupling system 10.

The optical coupling system 10 may be made of any suitable material, such as plastic or glass, for example. The optical coupling system 10 typically is made of an optical plastic material that has suitable molding capability and satisfies mechanical, thermal and optical requirements, as will be understood by persons skilled in the art in view of the description being provided herein. A suitable plastic material for this purpose is polyetherimide (PEI), such as Ultem PEI. Polycarbonate-based plastics may also be used for this purpose. Ultem PEI typically has a refractive index value of about 1.63. The optical fiber 40 typically has a refractive index value of about 1.49. Therefore, in this case, the refractive index-matching material 30 will have a refractive index value that is greater than or equal to 1.49 and less than or equal to 1.63.

The optical Tx portion 2 typically includes electrical driver circuitry (not shown for purposes of clarity) that delivers drive signals to the laser diode 3 to cause the laser diode 3 to produce a modulated optical data signal. The optical data signal produced by the laser diode 3 is collimated by the collimating lens 4 into a collimated light beam 50. A portion of the entrance surface 4a of the collimating lens 4 may include a surface that acts as a beam splitter to split off a portion 50a of the optical data signal and direct it toward the reflective surface or lens 5. The reflective surface or lens 5 may be a total internal reflection (TIR) lens or other type of reflective surface configured to direct the light portion 50a onto the FB monitoring lens 6. The FB monitoring lens 6 focuses the light onto the light-receiving surface of the photodiode 7. The photodiode 7 produces an electrical FB signal that is typically used to adjust the bias and modulation currents of the laser diode 3 in such a way that the average optical output power level of the laser diode 3 remains at a substantially constant, predetermined level. The optical FB monitoring system comprising the reflective surface or lens 5, FB monitoring lens 6 and the photodiode 7. The optical FB monitoring system is optional.

The collimated light beam 50 passes out of end 4b of the collimating lens 4 and propagates along an optical pathway 22 of the optical coupling system 10. The collimated light beam 50 is then incident on the RAF lens 20. The RAF lens 20 is typically a TIR lens formed in the material comprising the optical coupling system 10 by curving one surface to provide TIR of the incident collimated light beam 50. Alternatively, the RAF lens 20 may be a concave metallic surface, such as a parabolic or elliptical mirror, for example. The RAF lens 20 is designed to reflect the beam 50 in a particular direction and to focus the beam 50 into the end 40a of the optical fiber 40. In reflecting the beam 50, the RAF lens 20 folds the optical path by a reflection angle that is equal to, less than or greater than 90°, relative to the angle of incidence of the beam 50 on the RAF lens 20. The reflection angle typically ranges from between about 90° and 120°.

The optical Tx portion 2 and the optical coupling system 10 may be a unitary part or separate parts. Typically, the optical coupling system 10 and the optical Tx portion 2 are separate parts that mechanically couple with each other by suitable mating features formed on them. The gap 71 between the boxes 2 and 10 representing the optical Tx portion 2 and the optical coupling system 10, respectively, is intended to indicate an illustrative embodiment in which they are separate parts, or modules, that mechanically couple with one another by suitable mating features (not shown for purposes of clarity).

The optical communications module 1 shown in FIG. 1 could be an optical Rx module rather than an optical Tx module. For example, assuming for exemplary purposes that the optoelectronic device 3 is a light detector, such as a photodiode, rather than a light source, a light beam passing out of the end 40a of the fiber 40 would be incident on the RAF lens 20. The RAF lens 20 would then reflect and focus the light beam into the portion 2, which in this case would be an optical Rx portion. The lens 4 would then couple the light beam onto the light detector 3, which would convert the light beam into an electrical signal. The lens 4 could be eliminated, in which case the RAF lens 20 would focus the received light beam directly onto the light detector 3.

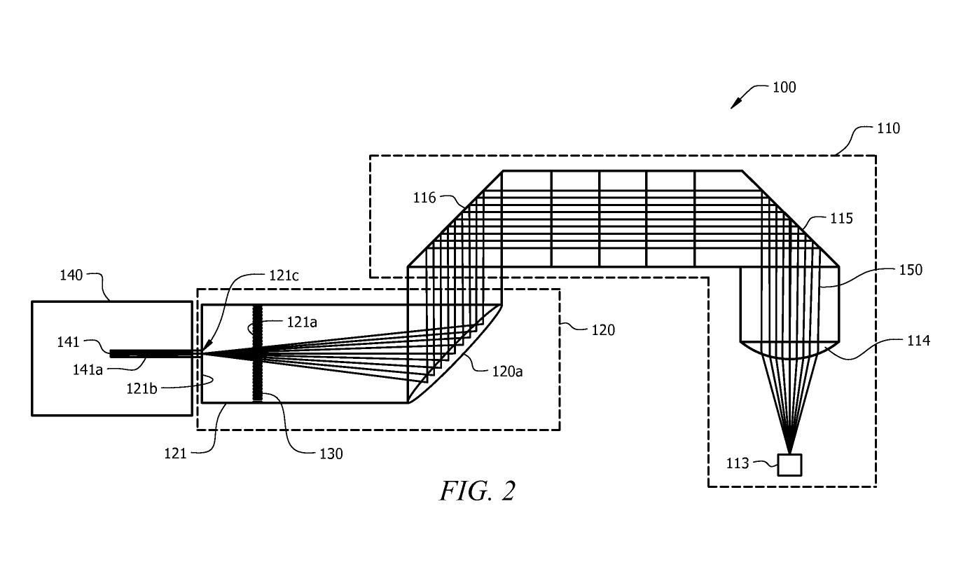

FIG. 2 illustrates a schematic side-view diagram of an optical communications module 100 that incorporates the optical coupling system 120 in accordance with another illustrative embodiment. The optical communications module 100 may be an optical Tx module, an optical Rx module, or an optical transceiver module. For demonstrative purposes, it will be assumed that the optical communications module 100 is an optical Tx module. The optical Tx module 100 has an optical Tx portion 110 that is similar to the optical Tx portion 2 shown in FIG. 1, except that the Tx portion 110 does not include a FB monitoring system and includes additional optical elements that fold the collimated light beam. The Tx portion 110 includes an optoelectronic device 113, a collimating lens 114, a first reflective surface or lens 115, and a second reflective surface or lens 116. In accordance with this embodiment, the optoelectronic device 113 is a light source 113. The light source 113 is typically a laser diode or an LED. The reflective surfaces or lenses 115 and 116 are typically surfaces that are curved to form TIR lenses.

The optical coupling system 120 includes an RAF lens 120a, a glass spacer 121, and a refractive index-matching material (e.g., a refractive index matching epoxy) 130 disposed in between a first end 121a of the glass spacer 121 and the RAF lens 120a. A connector 140 is adapted to mate with the optical Tx module 100. An end 141a of an optical fiber 141 is secured to the connector 140. The connector 140 mechanically couples with the optical Tx module 100 in such a way that the end 141a of the optical fiber 141 is inserted into an optical port 121c formed in a second end 121b of the glass spacer 121. Use of the glass spacer 121 enables the connector 140 to be connected to and disconnected from the Tx module 100 multiple times without damaging the optical coupling system 120. It should be noted that the spacer 121 may be made of suitable materials other than glass.

The optical coupling system 120 typically comprises a solid piece of material that is transparent to an operating wavelength of the laser diode 113. The material is “solid” in that no air gaps exist in the material unless an air gap has been intentionally formed by removing a portion of the material. The glass spacer 121 also is solid. The refractive index-matching material 130 covers the first ends 121a of the glass spacer 121 and ensures that no air gaps exist between the glass spacer 121 and the portion of the optical coupling system 120 to which the spacer 121 is secured. The end 141a of the optical fiber 141 is also covered with refractive index-matching material (not shown), such as epoxy. Therefore, no air gaps exist between the end 141a of the optical fiber 140 and the RAF lens 120a.

Like the optical coupling system 10 shown in FIG. 1, the optical coupling system 120 may be made of any suitable material, such as plastic or glass, for example. The optical coupling system 120 typically is made of an optical plastic material that has good molding capability and satisfies mechanical, thermal and optical requirements, as will be understood by persons skilled in the art in view of the description being provided herein. As indicated above, a suitable plastic material for this purpose is Ultem PEI.

The optical Tx portion 110 typically includes electrical driver circuitry (not shown for purposes of clarity) that delivers drive signals to the laser diode 113 to cause it to produce a modulated optical data signal. For purposes of discussion, it will be assumed that the light source 113 is a laser diode. The optical data signal produced by the laser diode 113 is collimated by the collimating lens 114 into a collimated light beam 150. The first reflective surface or lens 115 turns the collimated light beam by an angle of approximately 90° and causes it to be directed toward the second reflective surface or lens 116. The second reflective surface or lens 116 turns the collimated light beam 150 by an angle of approximately 90° and directs it toward the RAF lens 120a. The RAF lens 120a turns the collimated light beam 150 by an angle of approximately 90° and focuses it into the end 141a of the optical fiber 141 disposed in the optical port 121c formed in the glass spacer 121. Because there are no air gaps in the optical pathway that extends from the RAF lens 120a to the end 141a of the optical fiber 141, very little, if any, Fresnel reflection occurs along this optical pathway. Consequently, very little, if any, insertion loss or optical crosstalk occurs in the optical Tx module 100.

If the light source 113 instead were a light detector, the optical communications module 100 could operate as an optical Rx module. In this case, the light beam passing out of the end 141a of the fiber 140 would be incident on the RAF lens 120a. The RAF lens 120a would then reflect and focus the light on the reflective surface or lens 116, which would then reflect the light onto the reflective surface or lens 115. The reflective surface or lens 115 would then direct the light beam onto the light detector 113.

Although only a single channel has been described with reference to the optical communications modules 1 and 100, the modules 1 and 100 are typically parallel optical communications modules having multiple instances of the optoelectronic devices 3 and 113 and multiple parallel optical pathways along which the optical data signals travel in parallel. For ease of illustration, the side plan views of the optical communications modules 1 and 100 show only a single channel.

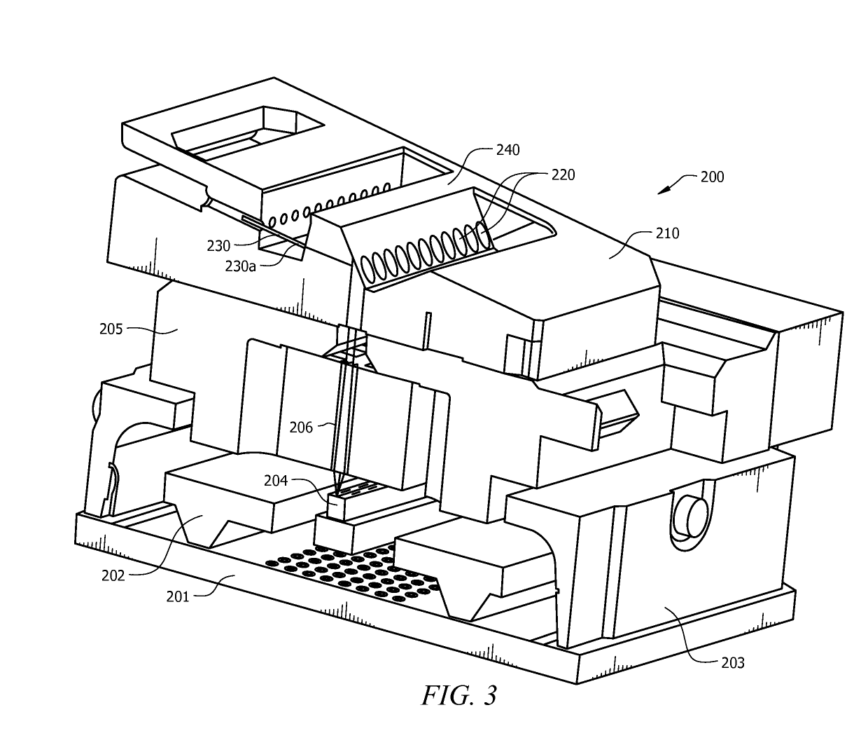

FIG. 3 illustrates a top perspective, cross-sectional view of a parallel optical communications module 200 that exemplifies one of many possible physical manifestations of the schematically-illustrated optical communications module 1 shown in FIG. 1. For ease of illustration, the optical FB monitoring loop is not shown in FIG. 3. In accordance with this illustrative embodiment, the module 200 has twelve parallel channels, although the module 200 could have any number of Tx and/or Rx channels or could be a single-channel Tx or Rx module. The module 200 includes a circuit board 201, a leadframe 202, a module housing 203, an array 204 of optoelectronic devices, a collimating lens assembly 205, and an optical coupling system 210. The leadframe 202 is disposed on top of the circuit board 201. The collimating lens assembly 205 is mechanically coupled by mechanical coupling features (not shown for purposes of clarity) with the module housing 203, which is disposed on top of the circuit board 201. The optical coupling system 210 is part of a connector module having mating features thereon (not shown for purposes of clarity) that mates with the collimating lens assembly 205 to mechanically couple the parts with one another.

The optical coupling system 210 includes twelve RAF lenses 220, each of which performs the reflecting and focusing operations described above with reference to the RAF lens 20 shown in FIG. 1. The optical coupling system 210 holds ends 230a of respective optical fibers 230. The ends 230a are disposed within respective optical ports (not shown for purposes of clarity) formed in a portion 240 of the optical coupling system 210. When disposed within the optical ports, the respective ends 230a are located at respective focal points of the respective RAF lenses 220. Although not visible in FIG. 3, refractive index-matching material is disposed within these optical ports and covers the ends 230a of the fibers 230.

In accordance with an illustrative embodiment, the array 204 of optoelectronic devices is made up of twelve laser diodes. The collimating lens assembly 205 has twelve collimating lenses 206 formed therein for collimating the respective beams of light produced by the respective laser diodes of the array 204. Each collimated beam of light passes out of the respective collimating lens 206 and is incident on a respective RAF lens 220. Each respective RAF lens 220 reflects the respective light beam in a direction toward the end 230a of the respective fiber 230 and focuses the respective light beam into the respective end 230a of the respective fiber 230.

The portion 240 of the optical coupling system 210 is a solid piece of material, such as Ultem PEI, that is transparent to the operating wavelength of the laser diodes of the array 204. No air gaps exist in portion 240 in between the fiber ends 230a and the RAF lenses 220. The refractive index-matching material covers the ends 230a of the fibers 230. Therefore, no air gaps exist between the ends 230a of the fibers 230 and the optical ports formed in the portion 240. For this reason, very little, if any, Fresnel reflection occurs along the optical pathway that extends from the respective RAF lenses 220 to the respective fiber ends 230a. Consequently, very little, if any, insertion loss or optical crosstalk occurs in the optical Tx module 200 as a result of the Fresnel loss at the module/fiber interface.

It should be noted that the invention has been described with respect to illustrative embodiments for the purpose of describing the principles and concepts of the invention. The invention is not limited to these embodiments. For example, while the invention has been described with reference to a few optical Tx module configurations, the invention is not limited to these particular configurations, as will be understood by those skilled in the art in view of the description being provided herein. Also, the invention is not limited to the optical coupling system having the configuration shown in FIGS. 1, 2 and 3. For example, the invention is not limited with respect to the manner in which the collimated light beam is folded before and/or after being reflected and focused by the RAF lenses into the ends of the fibers. As another example, while each of the optical coupling systems 10, 120 and 210 show a single RAF lens, multiple RAF lenses and/or other optical elements may be included in the optical coupling systems 10, 120 and 210, as will be understood by persons skilled in the art in view of the description being provided herein. The invention also is not limited with respect to the type of material that is used for the optical coupling system. As will be understood by those skilled in the art in view of the description being provided herein, many modifications may be made to the embodiments described herein without deviating from the goals of the invention, and all such modifications are within the scope of the invention.

What is claimed is:

1. An optical transmitter (Tx) module comprising:
an optical Tx portion, the optical Tx portion including at least a first light source for producing a first light beam and a first collimating lens for collimating the first light beam to produce a first collimated light beam;
an optical coupling system, the optical coupling system being positioned to receive a first collimated light beam corresponding to at least a portion of the first collimated light beam produced in the optical Tx portion, the optical coupling system having at least a first optical port having a first end of at least a first optical fiber mechanically coupled thereto, and wherein the optical coupling system includes at least a first reflective and focusing (RAF) lens that reflects the received first collimated light beam along a first optical pathway of the optical coupling system toward the first optical port and focuses the received collimated light beam on the first end of the first optical fiber, the first optical pathway extending from the first RAF lens to the first optical port, and wherein the optical coupling system is formed in a piece of material that is transparent to a wavelength of the first light beam produced by the first light source and that is devoid of air gaps at least along the first optical pathway; and
a refractive index-matching material disposed in between, and in contact with, the first optical port and the first end of the first optical fiber such that no air gaps exist in between the first optical port and the first end of the first optical fiber.

2. The optical Tx module of claim 1, wherein the piece of material in which the optical coupling system is formed is a plastic material.

3. The optical Tx module of claim 2, wherein the plastic material is polyetherimide (PEI).

4. The optical Tx module of claim 1, wherein the piece of material in which the optical coupling system is formed is glass.

5. The optical Tx module of claim 1, wherein the first RAF lens is a total internal reflection (TIR) lens comprising a curved surface formed in the piece of material.

6. The optical Tx module of claim 1, wherein the first RAF lens is a mirror.

7. The optical Tx module of claim 1, wherein the first RAF lens reflects the received first collimated light beam at an angle that ranges from between about 90° to about 120° relative to an angle of incidence of the received first collimated light beam on the first RAF lens.

8. The optical Tx module of claim 1, wherein the first end of the first optical fiber is held within a connector that mechanically couples with the first optical port.

9. The optical Tx module of claim 1, wherein the refractive index-matching material is epoxy, and wherein the first end of the first optical fiber is mechanically coupled directly to the first optical port by the epoxy.

10. The optical Tx module of claim 1, wherein the optical Tx portion further comprises at least a second light source for producing a second light beam and a second collimating lens for collimating the second light beam to produce a second collimated light beam, and wherein the optical coupling system is positioned to receive a second collimated light beam corresponding to at least a portion of the second collimated light beam produced in the optical Tx portion, the optical coupling system having at least a second optical port having a first end of at least a second optical fiber mechanically coupled thereto, and wherein the optical coupling system includes at least a second RAF lens formed in the piece of material, wherein the second RAF lens reflects the received second collimated light beam along a second optical pathway of the optical coupling system toward the second optical port and focuses the received second collimated light beam on the first end of the second optical fiber, and wherein the piece of material is transparent to a wavelength of the second light beam produced by the second light source and is devoid of air gaps at least along the second optical pathway, and wherein a refractive index-matching material is disposed in between, and in contact with, the second optical port and the first end of the second optical fiber such that no air gaps exist in between the second optical port and the first end of the second optical fiber.

11. The optical Tx module of claim 10, wherein the piece of material in which the optical coupling system is formed is a plastic material.

12. The optical Tx module of claim 11, wherein the plastic material is polyetherimide (PEI).

13. The optical Tx module of claim 10, wherein the piece of material in which the optical coupling system is formed is glass.

14. The optical Tx module of claim 10, wherein the first and second RAF lenses are total internal reflection (TIR) lenses comprising respective curved surfaces formed in the piece of material.

15. The optical Tx module of claim 10, wherein the first and second RAF lenses are minors.

16. The optical Tx module of claim 10, wherein the first RAF lens reflects the received first collimated light beam at an angle that ranges from between about 90° to about 120° relative to an angle of incidence of the received first collimated light beam on the first RAF lens, and wherein the second RAF lens reflects the received second collimated light beam at an angle that ranges from between about 90° to about 120° relative to an angle of incidence of the received second collimated light beam on the second RAF lens.

17. The optical Tx module of claim 10, wherein the first ends of the first and second optical fibers are held within a connector that mechanically couples with the optical Tx module such that the first ends of the first and second optical fibers mechanically couple with the first and second optical ports, respectively.

18. The optical Tx module of claim 10, wherein the refractive index-matching material is epoxy, and wherein the first ends of the first and second optical fibers are mechanically coupled directly to the first and second optical ports, respectively, by the epoxy.

19. An optical receiver (Rx) module comprising:
an optical Rx portion, the optical Rx portion including at least a first light detector for converting light received thereby into an electrical signal and a first optical element for optically coupling light onto the first light detector;
an optical coupling system, the optical coupling system being positioned to receive a first light beam passing out of an end of a first optical fiber coupled to a first optical port of the optical RX module, wherein the first light beam propagates along a first optical pathway of the optical coupling system, the optical coupling system including at least a first reflective and focusing (RAF) lens receives the first light beam propagating along the first optical pathway and reflects the received first light beam toward the first optical element of the optical Rx portion and focuses the reflected first light beam onto the first optical element of the optical Rx portion; and
a refractive index-matching material disposed in between, and in contact with, the first optical port and the first end of the first optical fiber such that no air gaps exist in between the first optical port and the first end of the first optical fiber.

20. The optical communications module of claim 19, wherein the piece of material in which the optical coupling system is formed is a plastic material.

21. The optical communications module of claim 20, wherein the plastic material is polyetherimide (PEI).

22. The optical communications module of claim 19, wherein the piece of material in which the optical coupling system is formed is glass.

23. The optical communications module of claim 19, wherein the first RAF lens is a total internal reflection (TIR) lens comprising a curved surface formed in the piece of material.

24. The optical communications module of claim 19, wherein the first RAF lens is a mirror.

25. The optical communications module of claim 19, wherein the first RAF lens reflects the received first collimated light beam at an angle that ranges from between about 90° to about 120° relative to an angle of incidence of the received first collimated light beam on the first RAF lens.

26. The optical communications module of claim 19, wherein the first end of the first optical fiber is held within a connector that mechanically couples with the first optical port.

27. The optical communications module of claim 19, wherein the refractive index-matching material is epoxy, and wherein the first end of the first optical fiber is mechanically coupled directly to the first optical port by the epoxy.

28. A method for optically coupling light output from an optical transmitter (Tx) portion of an optical Tx module into a first end of a first optical fiber coupled with a first optical port of the optical Tx module, the method comprising:
in an optical coupling system of the optical Tx portion, receiving a first collimated light beam from an optical Tx portion of the optical Tx module, the received collimated light beam being incident on a first reflecting and focusing (RAF) lens of the optical coupling system, wherein the optical coupling system is formed in a piece of material that is transparent to a wavelength of the first collimated light beam; and
with the first RAF lens, reflecting the received first collimated light beam along the first optical pathway toward the first end of the first optical fiber and focusing the first collimated light beam on the first end of the first optical fiber, wherein the piece of material is devoid of air gaps at least along the first optical pathway of the optical coupling system, and wherein a refractive index-matching material is disposed in between, and in contact with, the first optical port and the first end of the first optical fiber such that no air gaps exist in between the first optical port and the first end of the first optical fiber.

29. The method of claim 28, wherein the piece of material in which the optical coupling system is formed is a plastic material.

30. The method of claim 28, wherein the first RAF lens is a total internal reflection (TIR) lens comprising a curved surface formed in the piece of material.

31. A method for optically coupling light output from a first end of a first optical fiber onto a light detector of an optical receiver (Rx) portion of an optical Rx module, the first end of the first optical fiber being mechanically coupled with a first optical port of the optical Rx module, wherein the optical coupling system is formed in a piece of material that is transparent to a wavelength of the received light beam, the method comprising:
with a first reflecting and focusing (RAF) lens of an optical coupling system of the optical Rx module, receiving a light beam passing out of the first end of the first optical fiber and propagating along a first optical pathway that extends from the first end of the first optical fiber to the first RAF lens;
with the first RAF lens, reflecting and focusing the received light beam onto a first optical element disposed in the optical Rx portion of the optical Rx module; and
with the first optical element of the optical Rx portion, optically coupling the light beam focused thereon onto a first light detector of the optical Rx portion, wherein the piece of material in which the optical coupling system is formed is devoid of air gaps at least along the first optical pathway of the optical coupling system, and wherein a refractive index-matching material is disposed in between, and in contact with, the first optical port and the first end of the first optical fiber such that no air gaps exist in between the first optical port and the first end of the first optical fiber.

32. The method of claim 31, wherein the piece of material in which the optical coupling system is formed is a plastic material.

33. The method of claim 31, wherein the piece of material in which the optical coupling system is formed is glass.

34. The method of claim 31, wherein the first RAF lens is a total internal reflection (TIR) lens comprising a curved surface formed in the piece of material.
